(19) United States
(12) Patent Application Publication
(10) Pub. No.: US 2008/0238882 A1
(43) Pub. Date: Oct. 2, 2008

(54) SYMMETRIC TOUCH SCREEN SYSTEM WITH CARBON NANOTUBE-BASED TRANSPARENT CONDUCTIVE ELECTRODE PAIRS

(76) Inventors: RAMESH SIVARAJAN, Shrewsbury, MA (US); Michel Monteiro, Athol, MA (US); Thomas Rueckes, Rockport, MA (US); Brent M. Segal, Woburn, MA (US)

Correspondence Address: WILMERHALE/BOSTON, 60 STATE STREET, BOSTON, MA, 02109, US

(21) Appl. No.: 12/034,158

(22) Filed: Feb. 20, 2008

Related U.S. Application Data
(60) Provisional application No. 60/902,596, filed on Feb. 21, 2007.

(51) Int. Cl. G06F 3/041

(52) U.S. Cl. 345/174

(57) ABSTRACT

A symmetric touch screen switch system in which both the touch side and panelside transparent electrodes are comprised of carbon nanotube thin films is provided. The fabrication of various carbon nanotube enabled components and the assembly of a working prototype touch switch using those components is described. Various embodiments provide for a larger range of resistance and optical transparency for the both the electrodes, higher flexibility due to the excellent mechanical properties of carbon nanotubes. Certain embodiments of the symmetric, CNT-CNT touch switch achieve excellent optical transparency (<3% absorption loss due to CNT films) and a robust touch switching characteristics in an electrical test.

### CROSS REFERENCE TO RELATED APPLICATIONS

This application claims the benefit under 35 U.S.C. § 119(e) of the following applications, the entire contents of which are incorporated herein by reference:

U.S. Provisional Patent Application No. 60/902,596, entitled “Symmetric Touch Screen with Carbon Nanotube-Based Transparent Conductive Electrode Pair,” filed on Feb. 21, 2007.

### BACKGROUND

1. Technical Field

The present invention relates to touch screen and display systems having nanotube components and methods of forming such systems.

2. Discussion of Related Art

Conventional touch screens use indium tin oxide (ITO) as the transparent conducting electrode. Indium tin oxide is an oxide ceramic material exhibiting poor mechanical strength especially as a thin film. Hence ITO thin film coatings lose mechanical integrity upon bending, flexing or repeated stylus pokes.

Indium-tin oxide electrodes also show a significant wavelength dependency of transparency in the visible region of the electromagnetic spectrum.

Due to the low intrinsic resistance of indium tin oxide, fabrication of high resistance, transparent films for low power consumption applications turns out to be a difficult task mainly due to the poor mechanical strength of ITO thin films required to meet high resistances.

Use of conducting polymers for display and touch screen applications has been considered. However, polymeric films lack the right balance of characteristics including transparency versus conductivity and environmental/chemical stability when subject to light, heat and moisture.

### SUMMARY OF THE INVENTION

This invention relates generally to touch screen and display systems enabled by carbon nanotube films, wires, fabrics, layers, and articles. It further relates to the concepts used in building a touch screen system free from indium tin oxide (ITO) in which both of the ITO based transparent conductive elements are replaced by transparent conductive layers of CNT films.

In one embodiment, a resistive touch screen device includes a first and a second flexible electrode, each electrode having a sheet of nanotube fabric. The nanotube fabric includes a conductive network of unaligned nanotubes. The second flexible electrode disposed in spaced relation to the first flexible electrode. The resistive touch screen device further includes a plurality of spacing elements interposed between the first and second flexible electrodes, the spacing element defining a separation between the first and second flexible electrodes. Under pressure applied to a selected region of the first flexible electrode, the region substantially elastically deforms to reduce the separation, thereby forming an electrically conductive pathway between the first and second flexible electrodes.

According to one aspect, the first and second flexible electrodes each have a major planar surface and the major planar surface of the first flexible electrode and the major planar surface of the second flexible electrode are substantially aligned.

According to another aspect, the plurality of spacing elements comprise a dielectric material and are arranged to form an array, disposed along a major surface of at least one of the first and the second flexible electrodes.

According to another aspect, the array has selected intervals between adjacent spacers.

According to another aspect, the sensitivity of the device to pressure is determined, at least in part, by the selected intervals among adjacent spacers.

According to another aspect, the dielectric material comprises at least one of a polyacrylate material and an epoxie material.

According to another aspect, each of the first and second flexible electrodes are substantially optically transparent.

According to another aspect, an optical image projected on a surface of the second flexible electrode is detectable on a surface of the first flexible electrode.

According to another aspect, the resistive touch screen device is constructed and arranged such that a selected region of the first flexible electrode may be elastically deformed under applied pressure a plurality of repetitions without permanent deformation.

According to another aspect, the plurality of repetitions comprises at least 200 repetitions.

According to another aspect, the resistive touch screen further includes a flexible cover sheet, disposed in contact with and along a major planar surface of the first flexible electrode.

According to another aspect, the resistive touch screen device further includes a conductive substrate, disposed in contact with and along a major planar surface of the second flexible electrode.

According to another aspect, the conductive substrate comprises a material including at least one of a soda glass, an optical quality glass, a borosilicate glass, an alumino-silicate glass, a crystalline quartz, a translucent vitrified quartz, a polyester plastic and a polycarbonate plastic.

According to another aspect, the resistive touch screen device further includes at least one peripheral electrode, disposed substantially along a peripheral edge of the major planar surface of one of the first and second flexible electrodes, wherein the at least one peripheral electrode occupies at least a portion of said separation.

According to another aspect, the peripheral electrode comprise a material includes at least one of aluminum, silver, copper, gold, and a conducting polymeric composite material.

According to another aspect, the nanotube fabric comprises a non-woven aggregate of nanotube forming a plurality of conductive pathways along the fabric.

Under another embodiment, a method of forming a resistive touch-screen device is provided. The method includes providing a first flexible electrode comprising a sheet of nanotube fabric having a conductive network of unaligned nanotubes and providing a second flexible electrode comprising a sheet of nanotube fabric having a conductive network of unaligned nanotubes, the second flexible electrode disposed in spaced relation to the first flexible electrode. The method further includes forming a plurality of spacing elements interposed between the first and second flexible electrodes, the spacing element defining a separation between the first and second flexible electrodes. The method further includes constructing and arranging the first and second electrodes and plurality of spacing elements such that when pressure is applied to a selected region of the first flexible electrode, the region substantially elastically deforms to reduce the separation, thereby forming an electrically conductive pathway between the first and second flexible electrodes.

According to another aspect, the method includes constructing and arranging the first and second flexible electrodes such that a major planar surface of each of the first and second flexible electrodes are substantially aligned.

According to another aspect, forming the first and second flexible electrodes comprises providing substantially optically transparent electrodes.

According to another aspect, forming the second flexible electrode comprises spray coating a panel side substrate with a coating of nanotubes to form the sheet of nanotube fabric.

According to another aspect, the panel side substrate comprises a material including at least one of a soda glass, an optical quality glass, a borosilicate glass, an alumino-silicate glass, a crystalline quartz, a translucent vitrified quartz, a polyester plastic and a polycarbonate plastic.

According to another aspect, forming the first flexible electrode comprises spray coating a touch-side substrate with a coating of nanotubes to form the sheet of nanotube fabric.

According to another aspect, the touch side substrate comprises a plastic material including a PET material.

### BRIEF DESCRIPTION OF THE DRAWINGS

FIGS. 1A-B illustrate the basic components of a conventional touch-screen such as that using indium tin oxide or various conductive polymers as part of the transparent conductive electrodes.

FIGS. 2A-B illustrate an asymmetric touch screen in which a touch side electrode and a panel side electrode are made of different materials wherein one electrode includes CNTs and the other of electrode is comprised of conductive metal oxides, polymeric materials, or metal films.

FIGS. 3A-B illustrate a symmetric touch screen in which both a touch side electrode and a panel side electrode are made of material comprising a transparent conductive network of CNTs.

FIG. 4 presents results of resistance (ohms) versus position number after the use of a first spray coating technique to provide a CNT layer as a transparent electrode on the panel side of the specimen.

FIG. 5 presents results of resistance (ohms) versus position number on the panel side of the specimen after annealing and cooling.

FIG. 6 presents variation of optical transmittance of the CNT film as percent transmission versus wavelength (nm) when the specimen is measured in a spectrophotometer.

FIG. 7 presents results of resistance (ohms) versus position number after the use of a second spray coating technique to provide a CNT layer as a transparent electrode on the touch side of the specimen.

FIG. 8 presents results of resistance (ohms) versus position number on the touch side of the specimen after annealing and cooling.

FIG. 9 presents results of resistance (ohms) versus position number after the use of a third spray coating technique to provide a CNT layer as a transparent electrode on the touch side of the specimen.

FIG. 10 presents results of resistance (ohms) versus position number on the touch side of the specimen after annealing and cooling.

FIG. 11 illustrates the correlation between optical transmittance (percent at 550 nm) and electrical conductance (ohms⁻¹.sq) of the CNT layer on the touch side of the specimen after a first technique.

FIG. 12 illustrates the correlation between optical transmittance (percent at 550 nm) and electrical conductance (ohms⁻¹.sq) of the CNT layer on the touch side of the specimen after a second technique.

FIG. 13 illustrates components used in the construction of a working prototype CNT-CNT symmetric touch switch.

FIG. 14 provides a photograph of a fully assembled touch switch.

FIG. 15 shows a typical electrical switching result of a symmetric CNT-CNT resistance touch switch, resistance (ohms) versus number of switching cycles.

FIG. 16 illustrates transparency curves measured for both the touch switch stack and the optical transparency of the CNT-CNT electrode pair alone, with base line absorption adjusted to the stack absorption, percent transmittance versus wavelength (nm).

### DETAILED DESCRIPTION

A touch screen system consisting of symmetric transparent conductive electrodes, that are free of indium tin oxide (ITO) or any conductive polymers is disclosed herein. The concept and fabrication steps for making a touch screen system with carbon nanotube transparent conductive electrodes, symmetrically arranged, is described. Various embodiments of the touch screen system include a touch switch having carbon nanotube based electrodes symmetrically disposed. The disclosed carbon nanotube-carbon nanotube (CNT-CNT) symmetric touch switches are electrically characterized for switching several hundred times and showing high stack transparency.

Carbon nanotube (CNT) based transparent conducting electrodes have been considered for display and touch screen applications. Electrically conducting and optically transparent, fabric-like networks of CNT have been suggested as a general replacement of indium tin oxide electrodes in conventional touch-screens.

Various general methods for the fabrication of a CNT electrode have been suggested based on surfactant based suspension, polymer based suspension, a polymer base composite or a free standing CNT film prepared by filtration and transferred over to a solid substrates. Like conventional ITO applications, these methods again fail to produce the target film resistance or target light transmittance or both.

One such method includes that described in U.S. Patent Publication No. 2006/0274047 by Spath et al, filed Jun. 2, 2005, which details the use of carbon nanotube electrodes in an asymmetric touch screen system wherein only one of the conductive electrodes in a resistive touch screen (electrodes) is composed of carbon nanotubes.

The conventional, asymmetric touch screens have quite a few technical limitations as listed below that can be overcome by a symmetric touch screen described herein. The limitations of the conventional, asymmetric touch screens listed below are understood to be inclusive and not restrictive:

(a) Mechanical abrasion of one of the electrodes arising from repeated contacts of materials of different hardness against each other.

(b) Possibility for chemical damage caused due to the contact of materials with different redox potentials (e.g. ITO) against a conducting polymer

(c) The existence of a work function barrier between the conducting material on the touch side and device side leading difficulty in obtaining a clean ohmic contact resistance behavior with small barrier.

The present disclosure provides various embodiments of a touch screen system consisting of symmetric transparent conductive electrodes comprising carbon nanotube materials. The conductive electrodes are free of indium tin oxide (ITO) or any conductive polymers as part of the transparent conductive electrodes and that has been electrically characterized for switching several hundred times and showing high stack transparency. In the embodiments disclosed herein, both conductive electrodes of a resistive touch screen system are composed of carbon nanotubes.

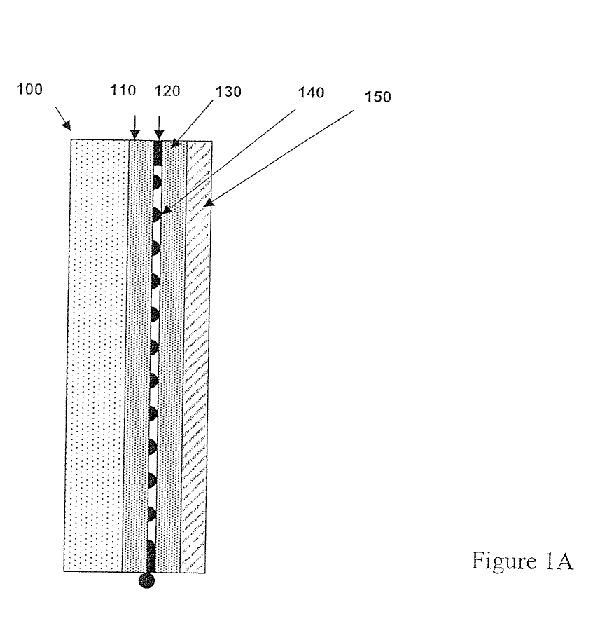

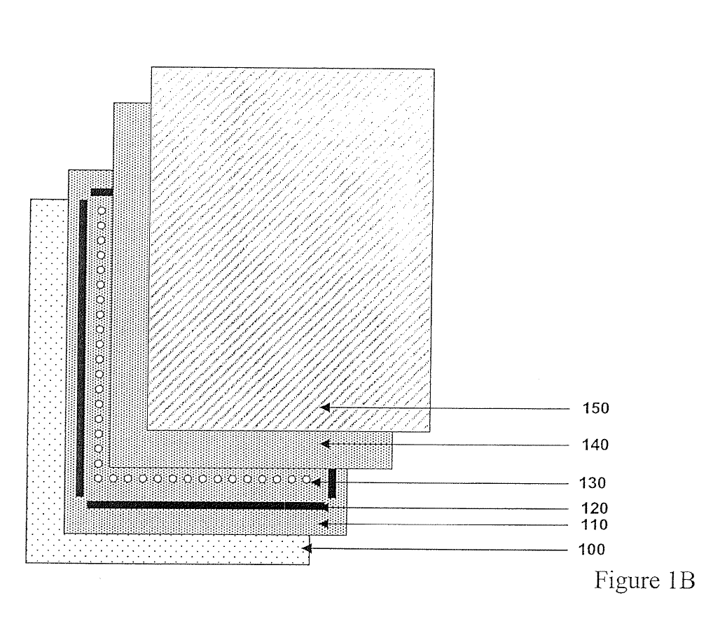

The basic components used in the current generation of conventional resistive touch screens are shown in FIG. 1A.

A conventional resistive touch screen consists of a conductive panel, where a solid transparent, non conductive substrate (100) (usually glass) is coated with an electrically conductive and optically transparent material. This electrode is typically referred to as a “device side electrode” or a “panel electrode” (110).

A conventional resistive touch screen also consists of a second electrode (130) that is a transparent, and comprises an electrically conductive material coating on a flexible sheet of plastic (150). This electrode is typically referred to as the “touch side electrode” or the “cover-sheet electrode” (130).

Plastics or polymers that can be used to form the flexible sheet of plastic (150) in various embodiments include but are not limited to: polyethylene terephthalate (PET), polyethylene naphthalate (PEN), polyethersulfone (PES), polycarbonates (PC), polysulfones, epoxy resins, polyesters, polyimides, polyetheresters, poly(vinyl acetate) (PVA), polystyrene (PS), cellulose nitrate, cellulose acetate, polyolefins, aliphatic polyurethanes, polyacrylonitrile (PAN), polytetrafluoroethylenes (PTFE), polyvinylidene fluorides (PVDF), poly(methyl (x-methacrylates) (PMMA) poly(ether ketone) (PEK) and poly(ether ether ketone) (PEEK).

To enable electrical contact between the conductive panel and the control electronics, non-transparent, low-resistance electrodes (120) are fabricated on the edges of the conductive panel. The geometry, dimensions and configuration of the electrodes vary, though in general they comprise narrow, electrically conductive strips at the edges of the conductive panel. They are typically referred to as “picture frame electrodes,” as well. The various possible configurations are shown in FIG. 1B, which illustrates the front view of the resistive touch screen panel with different constituent layers and their order of stacking. Generic picture frame materials in the current generation of touch screens are based either on metal (e.g. silver) paint or a metal (e.g. silver)-polymer-composite.

A conventional resistive touch screen also consists of dielectric spacers that are, in most instances, printed on to the conductive panel in the form of arrays (140). The touch sensitivity and resolution are dependent on the spacing, size and mechanical properties of the dielectric spacers.

When contact is induced between the device side electrode (110) and the touch side electrode (130) through a stylus poke or a finger touch an electrical contact is made between the touch side and panel side electrodes thus completing an electrical circuit. The position of the point of contact is sensed through a calibrated position-potential map.

As noted above, various general methods for the fabrication of a CNT electrode have been suggested. One such method includes that described in U.S. Patent Publication No. 2006/0274047 by Spath et al, filed Jun. 2, 2005, which details the use of carbon nanotube electrodes in an asymmetric touch screen system wherein only one of the conductive electrodes in a resistive touch screen (electrodes) is composed of carbon nanotubes.

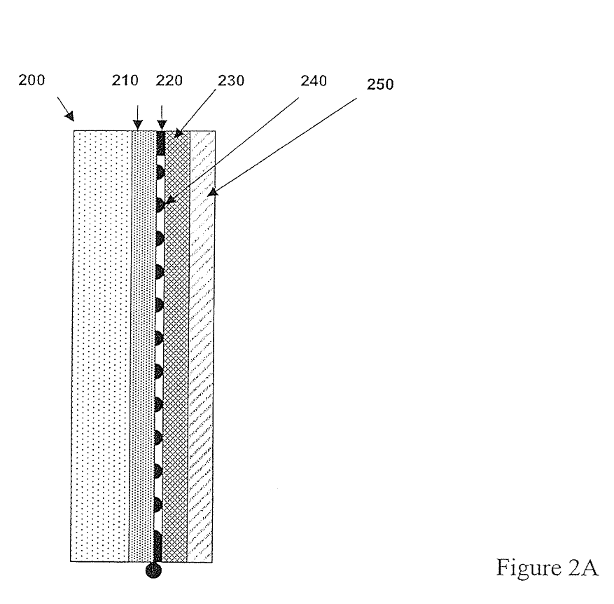

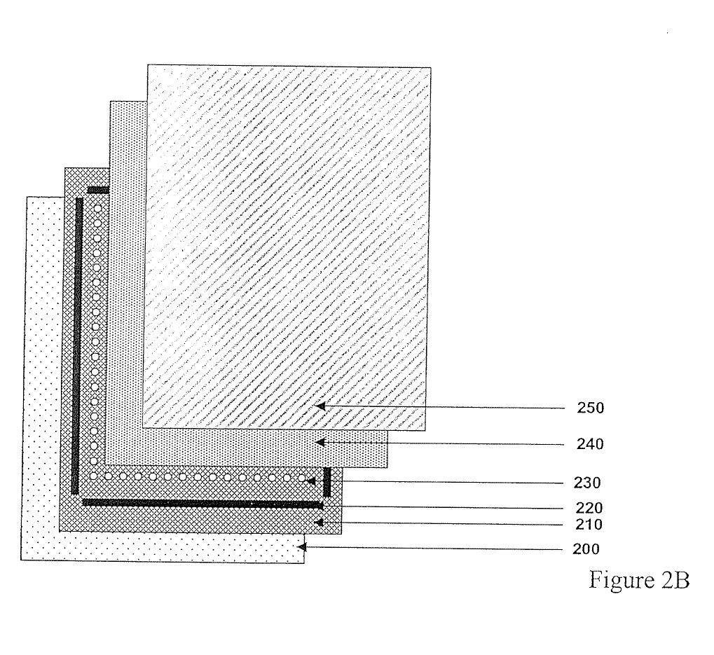

Spath et al, further states that the other conducting layer in the asymmetric, resistive touch screen to be necessarily comprised of conductive metal oxides, or conductive polymeric materials or conductive metal films. FIG. 2A shows an example of such an asymmetric touch screen wherein the touch side electrode (230) and the panel side electrodes (210) are made of different materials and one of them is comprised of carbon nanotubes. FIG. 2B shows the front view of such an asymmetric resistive touch screen panel with different constituent layers and their order of stacking.

Certain embodiments of the disclosed structure include a carbon nanotube enabled symmetric CNT-CNT resistive touch screen system that has both the panel side and touch side transparent electrodes comprised of carbon nanotubes. Such embodiments take advantage not only of a single layer of CNT film, but the advantages of a tactile switch based on CNT-CNT contact switch.

The following section provides a summary of distinct advantages arising from a symmetric CNT-CNT touch screen and distinguishing it from conventional and/or asymmetric touch screens are summarized. Inventors envision additional advantages that arise from alternate embodiments. The following section is understood to be inclusive and not restrictive.

(a) The CNT-CNT contact in a symmetric switch ensures there is no mechanical abrasion of one of the electrodes which is otherwise the case in an asymmetric electrode system with materials of two different hardnesses.

(b) The CNT-CNT contact in a symmetric switch further eliminates or minimizes the chances of chemical damage to the carbon nanotubes caused by repeated contact with an oxide based electrode like ITO or a conducting polymer based electrode.

(c) The CNT-CNT contact in a symmetric switch further eliminates or minimizes the deterioration of the electrical properties of the carbon nanotubes caused by repeated contact with an oxide based electrode like ITO or a conducting polymer based electrode.

(d) The CNT-CNT contact in a symmetric switch further enhances ohmic contact between the panel side and touch side electrodes by the absence of a work function difference between two different kinds of electrical conductors.

(e) The CNT-CNT contact in a symmetric switch further provides for a very high range of electrical resistances (100 ohms/square to several hundred Mega Ohms/square) and transparencies (up to 99%) for both the touch side and panel side electrodes.

(f) The CNT-CNT contact in a symmetric switch further provides for a high electrical resistances for the panel side electrode and or the touch side electrode thus provide for high positional resolution for a given spacer arrangements.

(g) The CNT-CNT symmetric switch further provides for minimal variation of transparency of the entire stack with wavelength range of 500-650 nm compared to ITO in the same visibly sensitive region.

(h) The CNT-CNT symmetric electrode system further provides for the replacement of both the panel side and touch side electrode system with a flexible plastic substrate such that the entire switching stack is flexible taking advantage of the excellent mechanical properties of CNT for both the electrodes.

(i) Since the CNT-CNT symmetric electrode system further provides for the reel-to-reel manufacture of the entire touch screen stack by building the CNT electrodes on flexible substrates for both the panel side and touch side electrodes the cost of constructing an all plastic, flexible touch screen is made viable.

The CNT-CNT symmetric electrode system, in certain embodiments, also provides fabrication or manufacturing advantages, as compared to conventional touch-screens. The CNT-CNT symmetric electrode system is more suitable for the cost effective reel-to-reel manufacture of the entire touch screen stack by building the CNT electrodes on flexible substrates for both the panel side and touch side electrodes the cost of constructing an all plastic, flexible touch screen. The manufacturing process does not require expensive sputter chambers as is the case with indium tin oxide or tightly controlled, moisture or oxygen free ambience required in the case of conducting polymeric materials.

A symmetric CNT-CNT touch screen is functionally similar to the conventional touch screens in terms of the general sensing mechanism. When contact is induced between the device side electrode and the touch side electrode through a stylus poke or a finger touch an electrical contact is made between the touch side and panel side electrodes thus completing an electrical circuit. The position of the point of contact is sensed through a calibrated position-potential map.

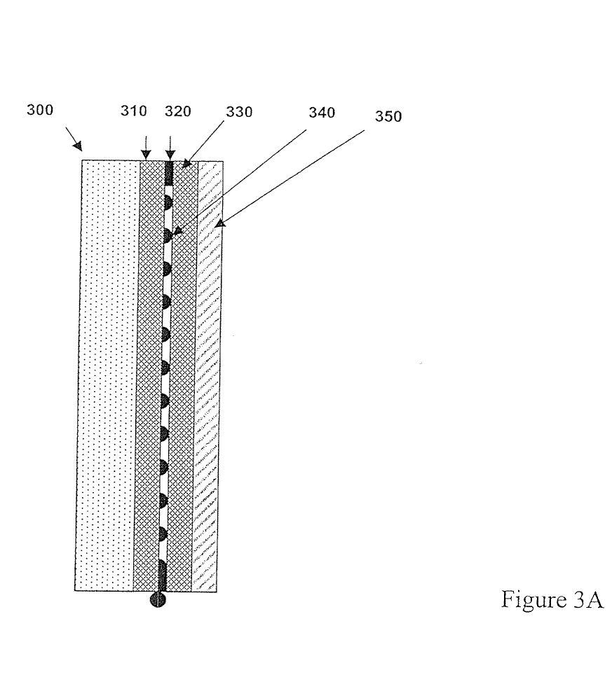

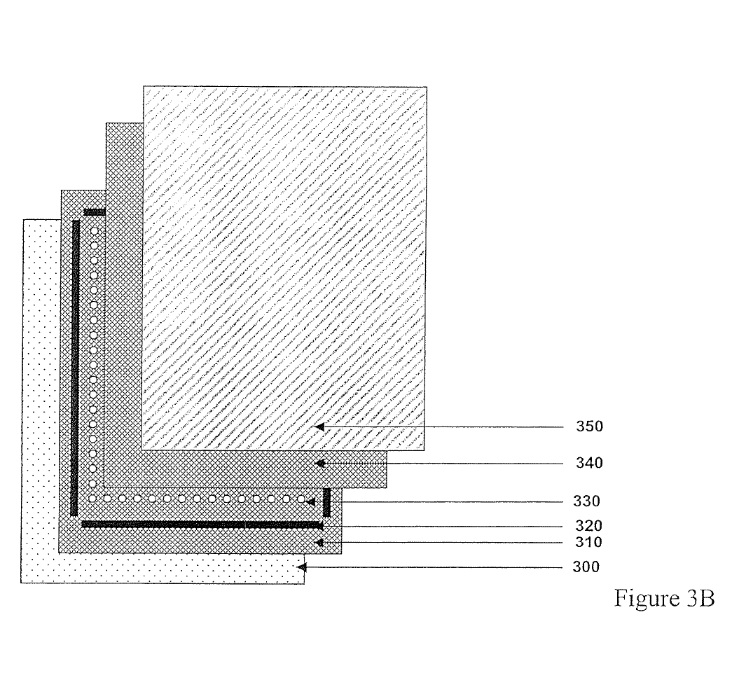

FIG. 3A shows the schematic view of a symmetric, resistive touch screen presently described wherein both the touch side electrode (330) and the panel side electrode (310) are made of a transparent conductive network of carbon nanotubes. FIG. 3B shows the front view of such a symmetric, resistive touch screen panel with various constituent layers and their order of stacking. In various embodiments, the conductive substrate (300) may be composed of materials including: soda glass, optical quality glass, borosilicate glass, alumino-silicate glass, crystalline quartz, translucent vitrified quartz, plastics including any form of polyester or polycarbonates or other suitable materials. Low-resistance electrodes (320) are fabricated on the edges of a conductive panel and may be composed of materials including: aluminum, silver, copper or gold or a dispersion of these metals alone or in combination in the form of a conducting polymeric composite or other material known in the art and appropriate to the particular applications. Dielectric spacers (340) may be composed of materials including but not limited to polyacrylates and epoxies. The flexible plastic cover sheet (350) is exposed to the user on the outside and coated with CNT on the inner side. Materials listed herein are understood to be inclusive but not restrictive, since other materials may be more appropriate for alternate embodiments of the present symmetric CNT touch-screen.

Methods of forming and providing transparent conductive networks of carbon nanotubes, and carbon nanotube films and articles are fully described in U.S. Pat. Nos. 6,706,402, 6,942,921, and 6,835,591, as well as U.S. patent application Ser. Nos. 10/341,005, 10/341,055, and 10/341,130, the contents of which are herein incorporated by reference in their entirety.

Electrically conductive articles may be made from a nanotube fabric, layer, or film. Carbon nanotubes with tube diameters as little as 1 nm are electrical conductors that are able to carry extremely high current densities, see, e.g., Z. Yao, C. L. Kane, C. Dekker, Phys. Rev. Lett. 84, 2941 (2000). They also have the highest known heat conductivity, see, e.g., S. Berber, Y.-K. Kwon, D. Tomanek, Phys. Rev. Lett. 84, 4613 (2000), and are thermally and chemically stable, see, e.g., P.M. Ajayan, T. W. Ebbesen, Rep. Prog. Phys. 60, 1025 (1997). However, using individual nanotubes is problematic because of difficulties in growing them with suitably controlled orientation, length, and the like. Nanotube fabrics have benefits not found in individual nanotubes. For example, since fabrics are composed of many nanotubes in aggregation, their conductivity will not be compromised as a result of a failure or break of an individual nanotube. Instead, there are many alternate paths through which electrons may travel within a carbon nanotube network. In effect, articles made from nanotube fabric have their own electrical network of individual nanotubes within the defined article, each of which may conduct electrons. Thus for touch-screen applications, nanotube fabrics and network of nanotubes have various advantages in terms of conductivity and resilience. Optical characteristics and the transparency of carbon nanotubes and networks of carbon nanotubes are well known in the art. Techniques for forming transparent conductive networks of nanotubes are also well known in the art and will not be further described here.

Techniques for preparing and creating films and fabrics of nanotubes on a variety of substrates by using applicator liquids are described in detail in U.S. patent application Ser. No. 11/304,315, and U.S. patent application Ser. No. 10/860,331, the entire contents of which are herein incorporated by reference. Other techniques for providing non-woven fabrics and layers comprising pre-formed nanotubes are detailed in U.S. patent application Ser. No. 10/341,054, the entire contents of which are also incorporated by reference.

U.S. Pat. Nos. 6,643,165 and 6,574,130, herein incorporated by reference, describe electromechanical switches using flexible nanotube-based fabrics (nanofabrics) derived from solution-phase coatings of nanotubes in which the nanotubes first are grown, then brought into solution, and applied to substrates at ambient temperatures. Nanotubes may be derivatized in order to facilitate bringing the tubes into solution, however in uses where pristine nanotubes are necessary, it is often difficult to remove the derivatizing agent. Even when removal of the derivatizing agent is not difficult, such removal is an added, time-consuming step. Conventionally, the solvents used to solubilize, disperse the carbon nanotubes are organics: ODCB, chloroform, ethyl lactate, to name just a few. The solutions are stable but the solvents have the disadvantage of not solubilizing clean carbon nanotubes which are free of amorphous carbon. U.S. patent application Ser. No. 11/304,315 details a method to remove most of the amorphous carbon and solubilize the carbon nanotubes at high concentrations in water via pH manipulation, so that carbon nanotubes may be delivered by coating techniques known in the art.

With regard to application of purified nanotubes, using proper bulk nanotube preparations which contain primarily metallic or semiconducting nanotubes allows application of a nanotube fabric to a substrate. The application may be performed via spin coating of a nanotube stock solution onto a substrate, spraying of nanotube stock solutions onto a surface or other methods. Application of single-walled, multiwalled or mixtures of such nanotubes may be also controllably performed. These application techniques are described in U.S. patent application Ser. No. 10/431,054 and are known in the art.

The present symmetric CNT-CNT touch screen takes advantage of the abovementioned methods and techniques in forming transparent carbon nanotube based conductive electrode pairs for touch-screen applications. Various embodiments of the present device and structure are detailed in the following examples.

### EXAMPLE 1

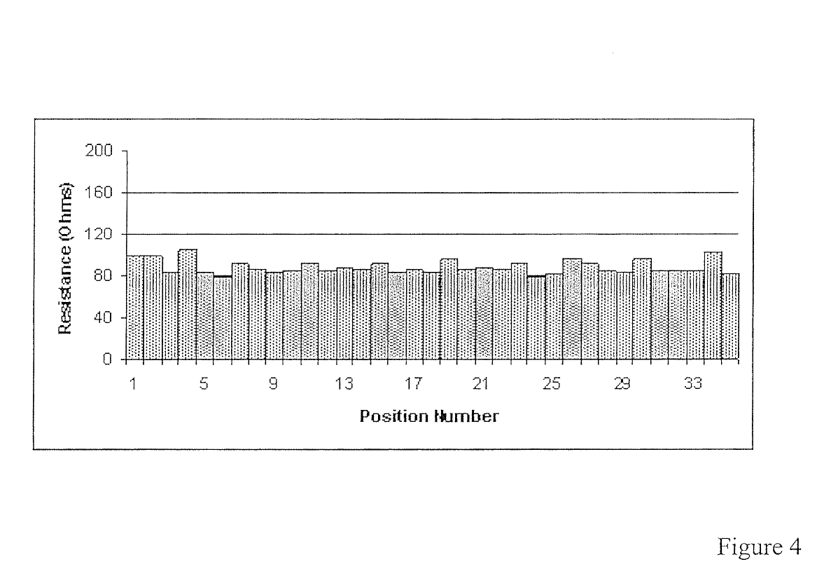

One of the components, a glass substrate coated with carbon nanotubes for the panel side transparent electrode, was fabricated as follows. Nantero proprietary, CMOS grade suspension of carbon nanotubes (standard NTSL-4 diluted 2.5× times by DI water and pH adjusted to 7.5) in water was used in this example, and is known in the art. There are no molecular surfactants or polymeric suspension agents used in the formation of the CNT suspension. The details are more fully described in U.S. patent application Ser. No. 11/304,315, the entire contents of which are herein incorporated by reference. In a typical coating process, a glass substrate measuring 8″×10″ in size was placed on a hotplate set at 125 C. The NTSL-4 solution was spray coated from the top using an air-spray nozzle connected to an X-Y-Z robot. The spray coating was done in a specially designed coat chamber equipped with complete aerosol isolation for the operator and a two stage filtration chambers for sample transfer. Air flowing at a rate of 14 SCFH with line pressure 60 PSI was used for spray coating. The NTSL-4 liquid was delivered to the spray nozzle expansion zone at the rate of 0.5 ml/min. The spray nozzle inclined at an angle of 30 degrees to the coated surface was programmed to scan the coat surface in straight horizontal and vertical patterns. The scanning of the entire surface was repeated 18 times to produce the target specimen. During the entire coating process the inner coat chamber was maintained at 80 F and less than 30% relative humidity. On completion of spray coating the hot plate was cooled and the specimen was characterized for electrical properties. Linear four probe resistance measurements (21 Volts maximum; 1 micro ampere current flow) were made on more than 30 points evenly spread across the entire sample. The mean resistance was measured to be 87.6 ohms with a resistance uniformity variation of 7.6%. The results are shown in FIG. 4.

### EXAMPLE 2

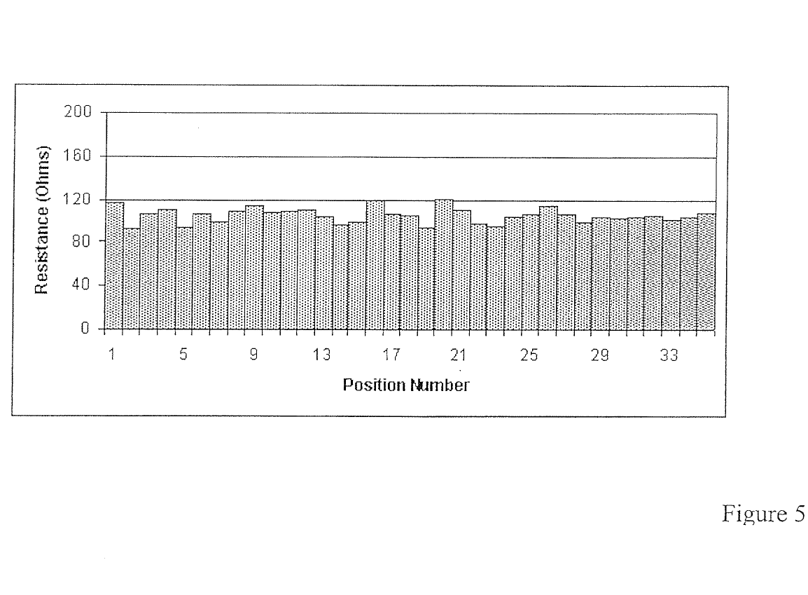

The specimen sample prepared as described in example 1 above, was annealed in a vacuum (<10⁻² bar) oven at 120° C. for one hour. On completion of annealing the sample was allowed to cool to room temperature inside the vacuum oven and transferred for electrical characterization. Linear four probe resistance measurements (21 Volts maximum; 1 micro ampere current flow) were made on more than 30 points evenly spread across the entire sample. The mean resistance was measured to be 105.7 ohms with a resistance uniformity variation of 6.5%. The results are shown in FIG. 5.

### EXAMPLE 3

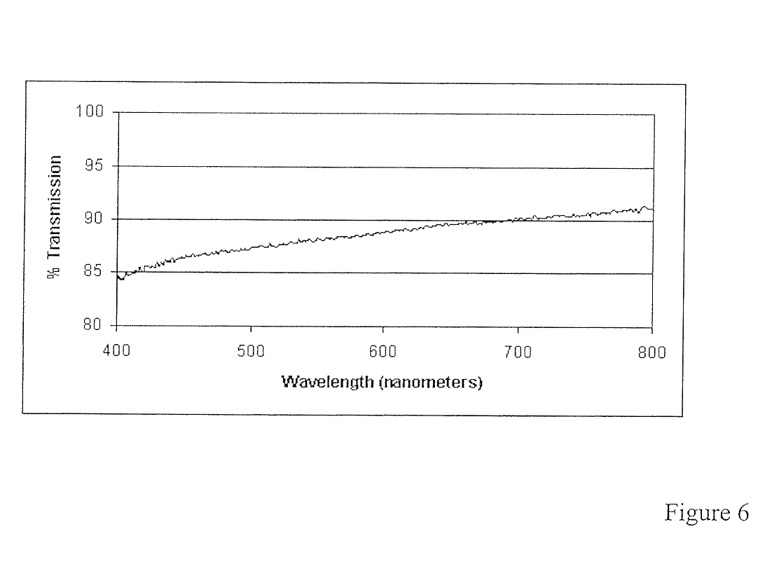

A portion of the annealed sample described in example 2 above measuring 3″×8″ was cut of the larger specimen and further cut into smaller pieces to fit into a spectrophotometer. Optical transmission of the sample in the 300-900 nm range was measured in a Shimadzu UV3101 PC spectrophotometer. Blank glass substrates of similar sample dimensions were used to measure the substrate baseline absorption losses. The CNT film with an electrical conductivity of 105.7 ohms (or 480 ohms/square) exhibited an optical transmission of >87% % at 550 nm. The variation of optical transmittance of the CNT film with wavelength is shown in FIG. 6.

### EXAMPLE 4

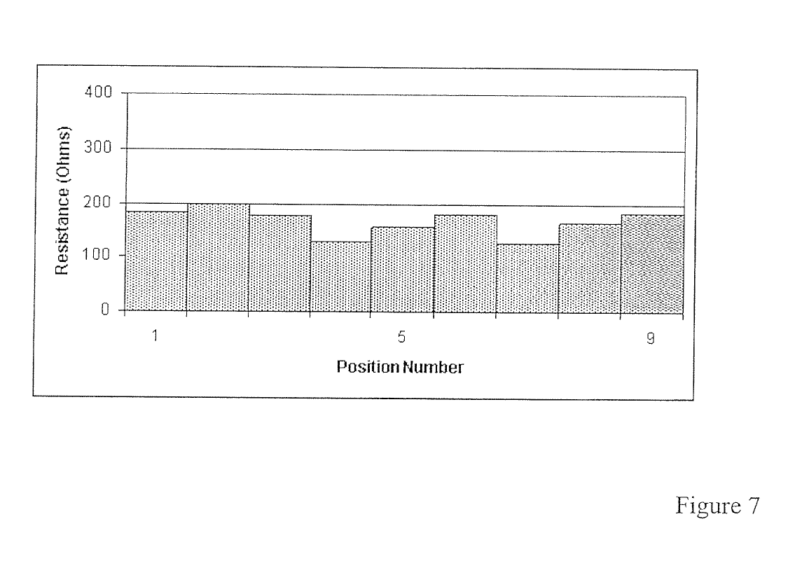

Yet another component for the symmetric touch screen, the plastic PET substrate (8.5″×9″) coated with carbon nanotubes for the touch side transparent electrode, was fabricated as follows. Nantero proprietary, CMOS grade suspension of carbon nanotubes (standard NTSL-4 diluted 1:2 diluted with DI water and pH adjusted to 7.5) in water was used to fabricate this sample. There were no molecular surfactants or polymeric suspension agents used in the formation of the CNT suspension. The details are described in U.S. patent application Ser. No. 11/304,315. In a typical coating process, a PET substrate measuring 8″×10″ in size was placed on a hotplate set at 105° C. The NTSL-4 solution was spray coated from the top on the ashed PET substrate using an air-spray nozzle connected to an X-Y-Z robot. The spray coating was done in a specially designed coat chamber equipped with complete aerosol isolation for the operator and a two stage filtration chambers for sample transfer. Air flowing at a rate of 14 SCFH with line pressure 60 PSI was used for spray coating. The NTSL-4 liquid was delivered to the spray nozzle expansion zone at the rate of 0.5 ml/min. The spray nozzle inclined at an angle of 30 degrees to the coated surface was programmed to scan the coat surface in straight horizontal and vertical patterns. The scanning of the entire surface was repeated 14 times to produce the target specimen. During the entire coating process the inner coat chamber was maintained at 82 F and 31% relative humidity. On completion of spray coating the hot plate was cooled and the specimen was characterized for electrical properties. Linear four probe resistance measurements (21 Volts maximum; 1 micro ampere current flow) were made on more than 30 points evenly spread across the entire sample. The mean resistance was measured to be 166.5 ohms with a resistance uniformity variation of 15%. The results are shown in FIG. 7.

### EXAMPLE 5

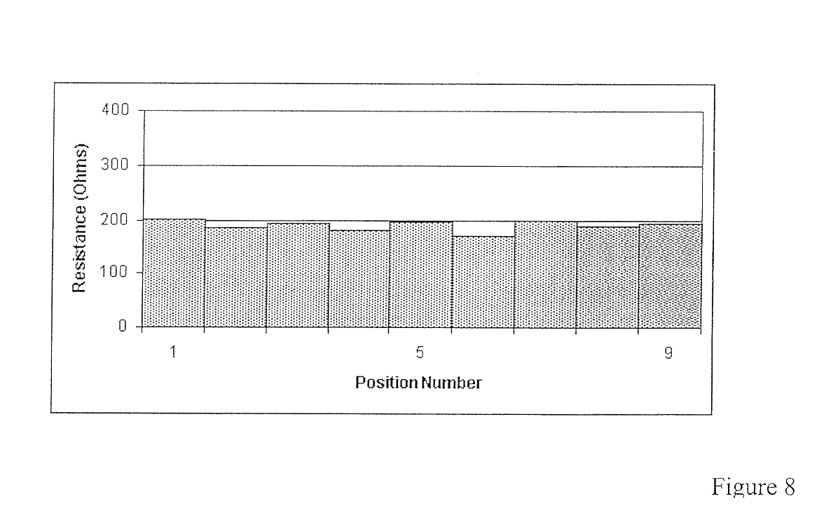

The specimen sample prepared as described in example 4 above, was annealed in a vacuum oven (<10⁻² bar) 120 C for one hour. On completion of annealing the sample was allowed to cool to room temperature inside the vacuum oven and transferred for electrical characterization. Linear four probe resistance measurements (21 Volts maximum; 1 micro Ampere current flow) were made on more than 30 points evenly spread across the entire sample. The mean resistance was measured to be 190.3 ohms with resistance uniformity variation of 5%. The results are shown in FIG. 8.

### EXAMPLE 6

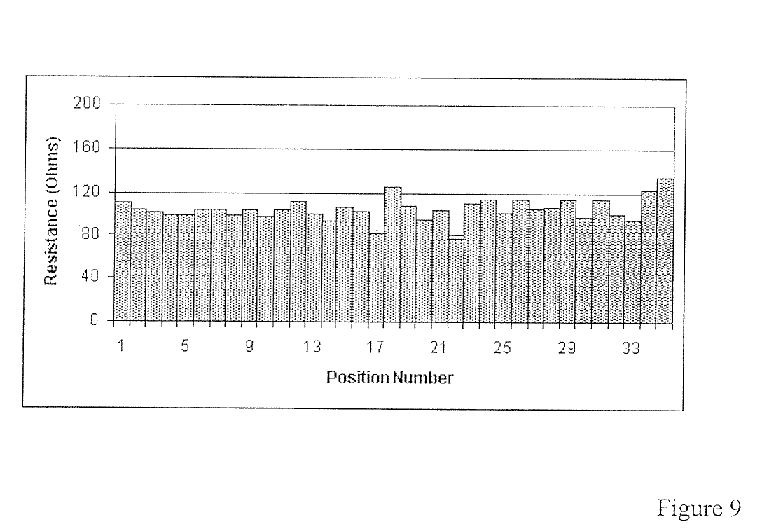

In yet another modification, one of the components for the symmetric touch screen, the plastic PET substrate coated with carbon nanotube for the touch side transparent electrode, was fabricated as follows. The commercial PET substrate measuring 9″×8.5″ was exposed to oxygen plasma in an asher for 5 minutes. Nantero proprietary, CMOS grade suspension of carbon nanotubes (standard NTSL-4 diluted 1:2 diluted with DI water and pH adjusted to 7.5) in water was used to fabricate this sample. There were no molecular surfactants or polymeric suspension agents used in the formation of the CNT suspension. The details are fully described in U.S. patent application Ser. No. 11/304,315. In a typical coating process, a PET substrate measuring 8″×10″ in size was placed on a hotplate set at 105 C. The NTSL-4 solution was spray coated from the top on the ashed PET substrate using an air-spray nozzle connected to an X-Y-Z robot. The spray coating was done in a specially designed coat chamber equipped with complete aerosol isolation for the operator and a two stage filtration chambers for sample transfer. Air flowing at a rate of 14 SCFH with line pressure at 60 PSI was used for spray coating. The NTSL-4 liquid was delivered to the spray nozzle expansion zone at the rate of 0.5 ml/min. The spray nozzle inclined at an angle of 30 degrees to the coated surface was programmed to scan the coat surface in straight horizontal and vertical patterns. The scanning of the entire surface was repeated 14 times to produce the target specimen. During the entire coating process the inner coat chamber was maintained at 82 F and 31% relative humidity. On completion of spray coating the hot plate was cooled and the specimen was characterized for electrical properties. Linear four probe resistance measurements (21 Volts maximum; 1 micro-Ampere current flow) were made on more than 30 points evenly spread across the entire sample. The mean resistance was measured to be 105 ohms with resistance variation of 10.3%. The results are shown in FIG. 9.

### EXAMPLE 7

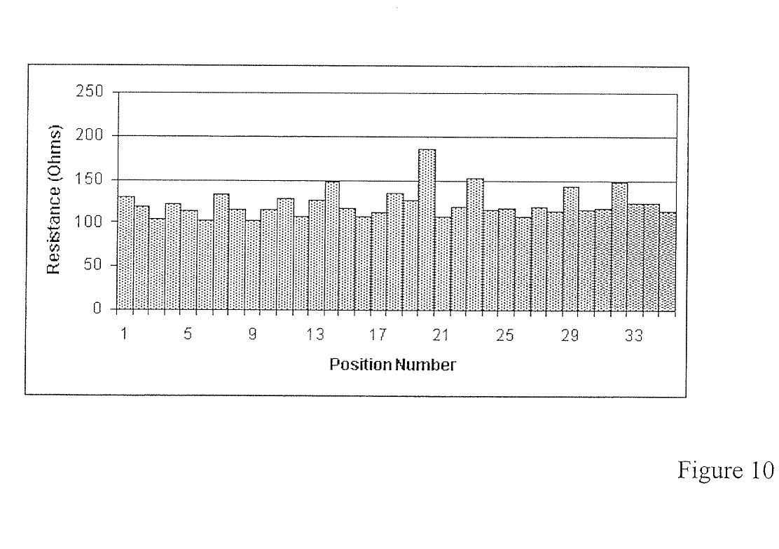

The specimen sample prepared as described in example 6 above, was annealed in a vacuum oven (<10⁻² bar) 120 C for one hour. On completion of annealing the sample was allowed to cool to room temperature inside the vacuum oven and transferred for electrical characterization. Linear four probe resistance measurements (21 Volts maximum; 1 micro ampere current flow) were made on more than 30 points evenly spread across the entire sample. The mean resistance was measured to be 123 ohms with a resistance variation of 13.5%. The results are shown in FIG. 10.

### EXAMPLE 8

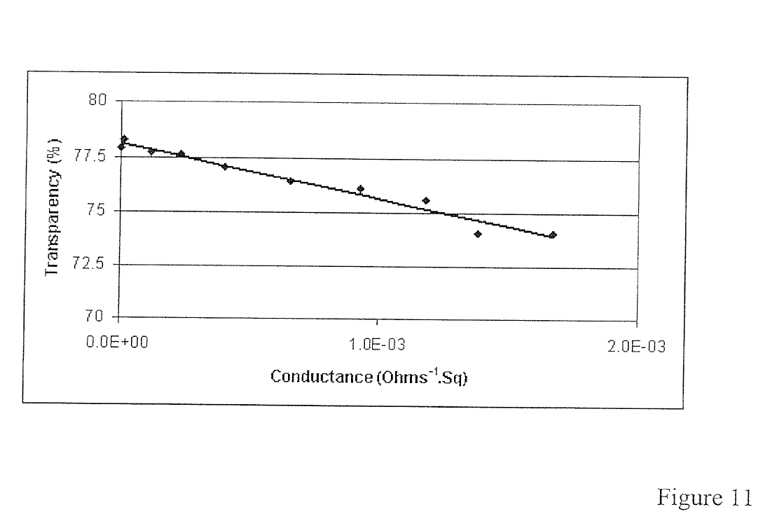

In yet another experiment, the correlation between transmittance and electrical conductance of one of the components, viz the plastic PET substrate coated with carbon nanotube for the touch side transparent electrode was measured by step wise carbon nanotube coating on the PET substrate and measurement of electrical conductance and optical transmittance as follows; Nantero proprietary, CMOS grade suspension of carbon nanotubes (standard NTSL-4 diluted 1:2 diluted with DI water and pH adjusted to 7.5) in water was used to coat a PET film. There were no molecular surfactants or polymeric suspension agents used in the formation of the CNT suspension. The details are described in U.S. patent application Ser. No. 11/304,315. In a typical coating process, a PET substrate measuring 2″×2″ in size was placed on a hotplate set at 115 C. The NTSL-4 solution was spray coated from the top on the ashed PET substrate using an air-spray nozzle connected to an X-Y-Z robot. The spray coating was done in a specially designed coat chamber equipped with complete aerosol isolation for the operator and a two stage filtration chambers for sample transfer. Air flowing at a rate of 14 SCFH with line pressure 60 PSI was used for spray coating. The NTSL-4 liquid was delivered to the spray nozzle expansion zone at the rate of 0.5 ml/min. The spray nozzle inclined at an angle of 30 degrees to the coated surface was programmed to scan the coat surface in straight horizontal and vertical patterns. The scanning of the entire surface was repeated 2 times to produce the target specimen for optical and electrical measurement. During the entire coating process the inner coat chamber was maintained at 82 F and less than 30% relative humidity. On completion of spray coating the hot plate was cooled and the specimen was transferred for characterization. linear four probe resistance measurements (21 Volts maximum; 1 micro ampere current flow) were made on several spots evenly spread across the entire sample. Optical transmission of the 2″×2″ sample in the 300-900 nm range was measured in a Shimadzu UV3101 PC spectrophotometer. Blank PET substrates of similar sample dimensions were used to measure the substrate baseline absorption losses. The mean electrical resistance and the optical transmission of the CNT film at 550 nm were recorded. After characterization, the substrate was transferred over to the coat chamber and the coating process repeated to give addition two coats. The characterization process and the re-coating of the process were repeated every two coats until a total of 20 coats were applied. The relation between the optical transmission at 550 nm and the electrical conductance of the CNT film is shown in FIG. 11.

### EXAMPLE 9

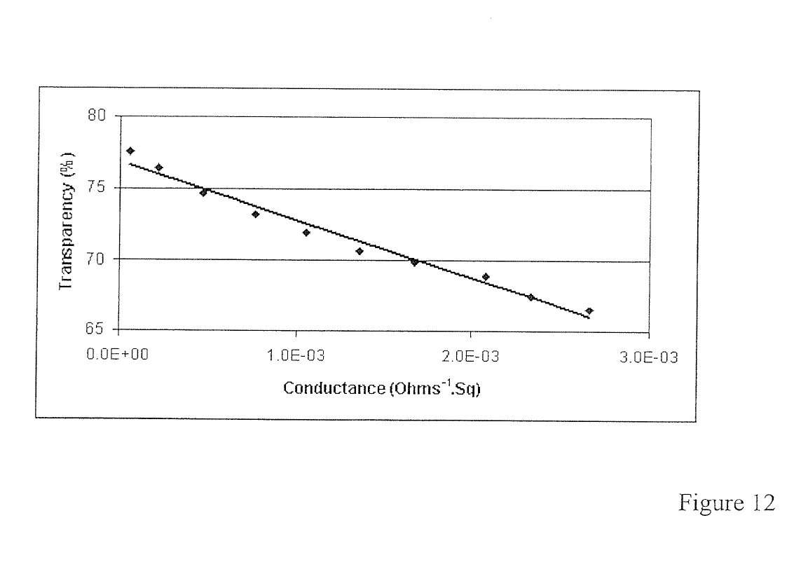

In yet another variation of the experiment described in example 8, the correlation between transmittance and electrical conductance of one of the components, the plastic PET substrate coated with carbon nanotube for the touch side transparent electrode, was measured by step wise carbon nanotube coating on the PET substrate and measurement of electrical conductance and optical transmittance as follows. The PET substrate measuring 2″×2″ was exposed to oxygen plasma in an asher for 5 minutes. Nantero proprietary, CMOS grade suspension of carbon nanotubes (standard NTSL-4 diluted 1:2 diluted with DI water and pH adjusted to 7.5) in water was used to coat a PET film. There were no molecular surfactants or polymeric suspension agents used in the formation of the CNT suspension. The details are described in U.S. patent application Ser. No. 11/304,315. In a typical coating process, a PET substrate measuring 2″×2″ in size was placed on a hotplate set at 115 C. The NTSL-4 solution was spray coated from the top on the ashed PET substrate using an air-spray nozzle connected to an X-Y-Z robot. The spray coating was done in a specially designed coat chamber equipped with complete aerosol isolation for the operator and a two stage filtration chambers for sample transfer. Air flowing at a rate of 14 SCFH with line pressure 60 PSI was used for spray coating. The NTSL-4 liquid was delivered to the spray nozzle expansion zone at the rate of 0.5 ml/min. The spray nozzle inclined at an angle of 30 degrees to the coated surface was programmed to scan the coat surface in straight horizontal and vertical patterns. The scanning of the entire surface was repeated 2 times to produce the target specimen for optical and electrical measurement. During the entire coating process the inner coat chamber was maintained at 82 F and less than 30% relative humidity. On completion of spray coating the hot plate was cooled and the specimen was transferred for characterization. Linear four probe resistance measurements (21 Volts maximum; 1 micro ampere current flow) were made on several spots evenly spread across the entire sample. Optical transmission of the 2″×2″ sample in the 300-900 nm range was measured in a Shimadzu UV3101 PC spectrophotometer. Blank PET substrates of similar sample dimensions were used to measure the substrate baseline absorption losses. The mean electrical resistance and the optical transmission of the CNT film at 550 nm were recorded. After characterization, the substrate was transferred over to the coat chamber and the coating process repeated to give addition two coats. The characterization process and the re-coating of the process were repeated every two coats until a total of 20 coats were applied. The relation between the optical transmission at 550 nm and the electrical conductance of the CNT film is shown in FIG. 12.

### EXAMPLE 10

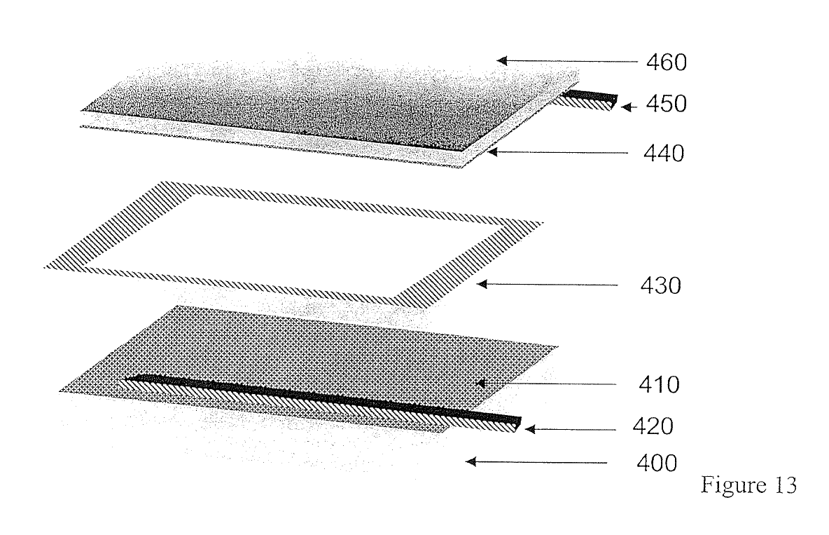

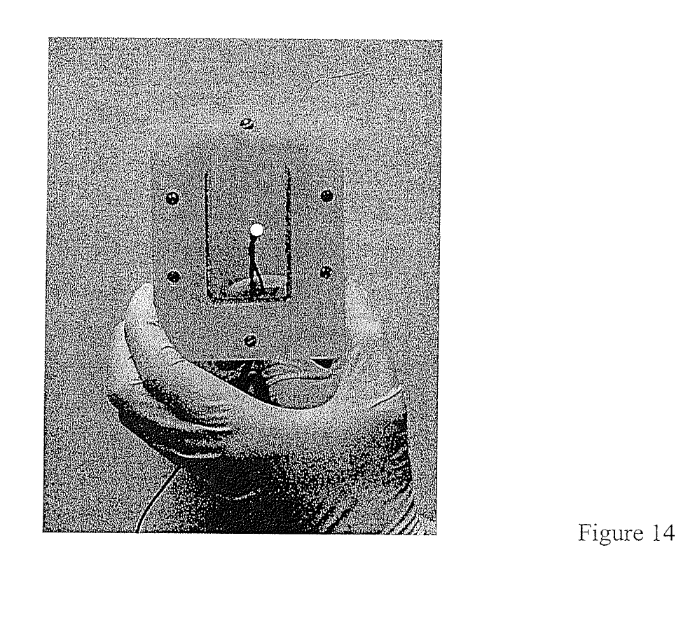

A working prototype of a CNT-CNT symmetric touch switch was constructed as follows using components shown in FIG. 13. A glass substrate (400) measuring 3″×2″ was coated with carbon nanotubes (410) employing procedures described in the examples above. The measured resistance of the CNT film was 10 k.ohms/square. A PET plastic substrate measuring 3″×2″ (460) was also deposited with carbon nanotubes (440) to reach a target resistance of 750 ohms/square employing procedures outlined in previous examples. Narrow strips of thin aluminum foils were attached to one edge each of the glass-CNT (420) and PET-CNT films (450) using commercial silver paste. A blank PET sheet was cut to size to form the spacer (430). Thin copper wire leads (not shown in the figure) were attached to the aluminum foil electrodes using commercial metal conductive tapes. The entire assembly was placed between two plastic holders and fastened to form a robust touch switch. A photograph of the fully assembled touch switch is shown in FIG. 14.

### EXAMPLE 11

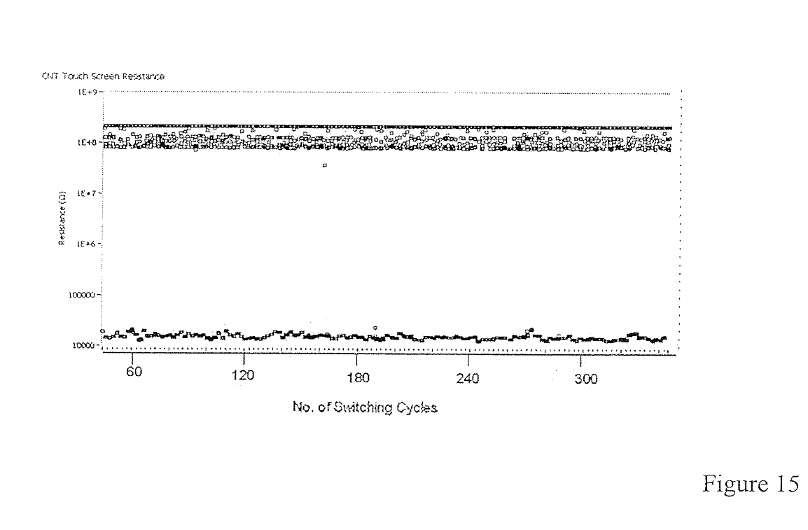

The prototype touch switch as described in example 10 above was connected to a computer interfaced Keithley constant current source. A constant current 10 micro amperes was passed through the device under test and the resistance was calculated by sensing the voltage drop. For every contacting position and open position the computer acquired about 10 data points. The switch was operated continuously for several hundred times. FIG. 15 shows a typical electrical switching result of the symmetric CNT-CNT resistance touch switch. When the viewing area of the touch switch was not touched the resistance between the wire leads read open (>10⁸ ohms). When the panel was touched with a finger tip at the middle of the switch, contact was made between the symmetric CNT electrode pairs of the touch switch with a closed circuit resistance of 14.5 k.ohm.

### EXAMPLE 12

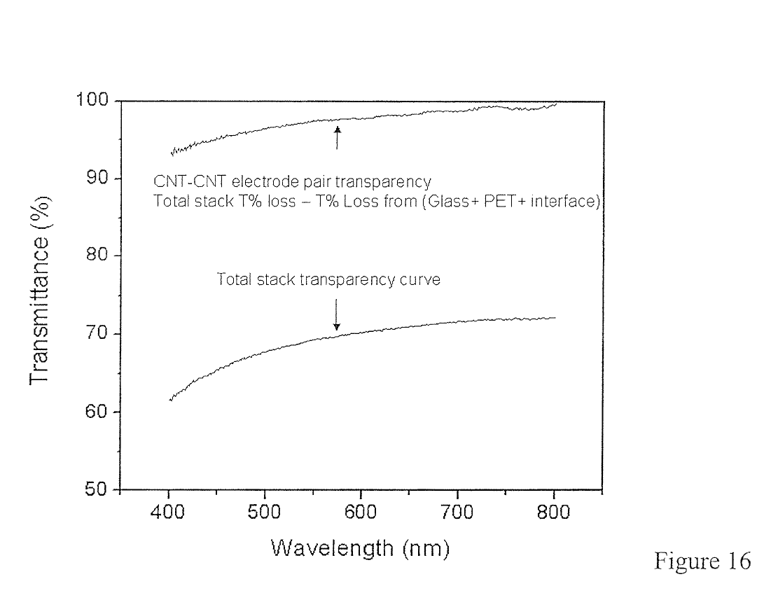

In yet another experiment the optical transparency of the entire touch screen stack as such was placed in a Shimadzu UV-Vis-NIR spectrophotometer for transparency measurements. A simple stack made by placing a blank PET substrate placed on top of a blank glass substrate was used for baseline purposes. The transparency curves measured for both the touch switch stack and the optical transparency of the CNT-CNT electrode pair alone (obtained by adjusting for base line absorption to the stack absorption) are shown in FIG. 16. The CNT-CNT electrode pair contributed to less than 3% optical absorption loss at 550 nm.

### CROSS-REFERENCE TO RELATED APPLICATIONS

This application is related to the following applications, all of which are assigned to the assignee of this application and all of which are herein incorporated by reference in their entireties:

Nanotube Films and Articles, U.S. patent application Ser. No. 10/776,573, filed Apr. 23, 2002 now U.S. Pat. No. 6,706,402;

Nanotube Films and Articles, U.S. patent application Ser. No. 10/776,573, filed Feb. 11, 2004, now U.S. Pat. No. 6,942,921;

Methods of Nanotube Films and Articles, U.S. patent application Ser. No. 10/128,117, filed Apr. 23, 2002, now U.S. Pat. No. 6,835,591;

Hybrid Circuit Having Nanotube Electromechanical Memory, U.S. patent application Ser. No. 09/095,095, filed Jul. 25, 2001, now U.S. Pat. No. 6,574,130;

Electromechanical Memory Having Cell Selection Circuitry Constructed with Nanotube Technology, U.S. patent application Ser. No. 09/915,173, filed Jul. 25, 2001, now U.S. Pat. No. 6,643,165;

Methods of Making Carbon Nanotube Films and Articles, U.S. patent application Ser. No. 10/341,005, filed Jan. 13, 2003;

Methods of Using Pre-Formed Nanotubes to Make Carbon Nanotube Films, Layers, Fabrics, Ribbons, Elements, and Articles, U.S. patent application Ser. No. 10/341,054, filed Jan. 13, 2003;

Methods of Using Thin Metal Layers to Make Carbon Nanotube Films, Layers, Fabrics, Ribbons, Elements, and Articles, U.S. patent application Ser. No. 10/341,055, filed Jan. 13, 2003;

Carbon Nanotube Films, Layers, Fabrics, Ribbons, Elements, and Articles, U.S. patent application Ser. No. 10/341,130, filed Jan. 13, 2003;

Applicator Liquid Containing Ethyl Lactate for Preparation of NT Films, U.S. patent application Ser. No. 10/860,433, filed Jun. 3, 2004, now U.S. Publication No. 2005/0269554;

Spin Coatable Liquid for Use in Electronic Fabrication Processes, U.S. patent application Ser. No. 10/860,432, filed Jun. 3, 2004, now U.S. Publication. No. 2005/0269553;

High Purity Nanotube Fabrics and Films, U.S. patent application Ser. No. 10/860,332, filed Jun. 3, 2004, now U.S. Publication. No. 2005/0058797;

Spin Coatable Liquid for Formation of High Purity Nanotube Films, U.S. patent application Ser. No. 10/860,433, filed Jun. 3, 2004, now U.S. Publication. No. 2005/0058590;

Aqueous Carbon Nanotube Applicator Liquids and Methods for Producing Applicator Liquids Thereof, U.S. patent application Ser. No. 11/304,315, filed Dec. 15, 2005, now U.S. Publication No. 2006/0204427; and

Methods of Making an Applicator Liquid for Electronics Fabrication Processes, U.S. patent application Ser. No. 10/860,331, filed Jun. 3, 2004.

It will be further appreciated that the scope of the present invention is not limited to the above-described embodiments. Other embodiments are within the following claims.

What is claimed is:

1. A resistive touch screen device comprising:
a first and a second flexible electrode, each electrode comprising a sheet of nanotube fabric having a conductive network of unaligned nanotubes, the second flexible electrode disposed in spaced relation to the first flexible electrode,
a plurality of spacing elements interposed between the first and second flexible electrodes, the spacing element defining a separation between the first and second flexible electrodes;
wherein under pressure applied to a selected region of the first flexible electrode, said region substantially elastically deforms to reduce the separation, thereby forming an electrically conductive pathway between the first and second flexible electrodes.

2. The resistive touch screen device of claim 1, wherein the first and second flexible electrodes each have a major planar surface and wherein the major planar surface of the first flexible electrode and the major planar surface of the second flexible electrode are substantially aligned.

3. The resistive touch screen device of claim 1, wherein the plurality of spacing elements comprise a dielectric material and are arranged to form an array, disposed along a major surface of at least one of the first and the second flexible electrodes.

4. The resistive touch screen device of claim 3, wherein the array comprises selected intervals between adjacent spacers.

5. The resistive touch screen device of claim 4, wherein the sensitivity of the device to said pressure is determined, at least in part, by the selected intervals among adjacent spacers.

6. The resistive touch screen device of claim 3, wherein the dielectric material comprises at least one of a polyacrylate material and an epoxie material.

7. The resistive touch screen device of claim 1, wherein each of the first and second flexible electrodes are substantially optically transparent.

8. The resistive touch screen device of claim 7, wherein an optical image projected on a surface of said second flexible electrode is detectable on a surface of said first flexible electrode.

9. The resistive touch screen device of claim 1, constructed and arranged such that a selected region of the first flexible electrode may be elastically deformed under applied pressure a plurality of repetitions without permanent deformation.

10. The resistive touch screen device of claim 9, wherein the plurality of repetitions comprises at least 200 repetitions.

11. The resistive touch screen device of claim 1, further comprising a flexible cover sheet, disposed in contact with and along a major planar surface of the first flexible electrode.

12. The resistive touch screen device of claim 1, further comprising a conductive substrate, disposed in contact with and along a major planar surface of the second flexible electrode.

13. The resistive touch screen device of claim 12, wherein the conductive substrate comprises a material including at least one of a soda glass, an optical quality glass, a borosilicate glass, an alumino-silicate glass, a crystalline quartz, a translucent vitrified quartz, a polyester plastic and a polycarbonate plastic.

14. The resistive touch screen device of claim 2, further comprising at least one peripheral electrode, disposed substantially along a peripheral edge of the major planar surface of one of the first and second flexible electrodes, wherein the at least one peripheral electrode occupies at least a portion of said separation.

15. The resistive touch screen device of claim 14, wherein the peripheral electrode comprise a material including at least one of aluminum, silver, copper, gold, and a conducting polymeric composite material.

16. The resistive touch screen device of claim 1, wherein nanotube fabric comprises a non-woven aggregate of nanotube forming a plurality of conductive pathways along the fabric.

17. A method of forming a resistive touch-screen device comprising:
providing a first flexible electrode comprising a sheet of nanotube fabric having a conductive network of unaligned nanotubes;
providing a second flexible electrode comprising a sheet of nanotube fabric having a conductive network of unaligned nanotubes, the second flexible electrode disposed in spaced relation to the first flexible electrode;
forming a plurality of spacing elements interposed between the first and second flexible electrodes, the spacing element defining a separation between the first and second flexible electrodes;
constructing and arranging the first and second electrodes and plurality of spacing elements such that when pressure is applied to a selected region of the first flexible electrode, said region substantially elastically deforms to reduce the separation, thereby forming an electrically conductive pathway between the first and second flexible electrodes.

18. The method of claim 17, further comprising constructing and arranging the first and second flexible electrodes such that a major planar surface of each of the first and second flexible electrodes are substantially aligned.

19. The method of claim 17, wherein the plurality of spacing elements comprise a dielectric material, are arranged to form an array, disposed along a major planar surface of at least one of the first and the second flexible electrodes.

20. The method of claim 19, wherein the array comprises selected intervals between adjacent spacers.

21. The method of claim 20, wherein the sensitivity of the device to said pressure is determined, at least in part, by the selected intervals between adjacent spacers.

22. The method of claim 19, wherein the dielectric material comprises at least one of a polyacrylate material and an epoxie material.

23. The method of claim 17, wherein forming the first and second flexible electrodes comprises providing substantially optically transparent electrodes.

24. The method of claim 23, wherein forming the second flexible electrode comprises spray coating a panel side substrate with a coating of nanotubes to form the sheet of nanotube fabric.

25. The method of claim 24, wherein the panel side substrate comprises a material including at least one of a soda glass, an optical quality glass, a borosilicate glass, an alumino-silicate glass, a crystalline quartz, a translucent vitrified quartz, a polyester plastic and a polycarbonate plastic.

26. The method of claim 23, wherein forming the first flexible electrode comprises spray coating a touch-side substrate with a coating of nanotubes to form the sheet of nanotube fabric.

27. The method of claim 26, wherein the touch side substrate comprises a plastic material including a PET material.
